(19) United States
(12) Patent Application Publication
(10) Pub. No.: US 2004/0181005 A1
(43) Pub. Date: Sep. 16, 2004

(54) Impact modified polymer compositions

(76) Inventors: Holger Warth, Dormagen (DE); Marc Vathauer, Koln (DE); Rolf Mulhaupt, Freiburg (DE); Christian Friedrich, Glottertal (DE); Olaf Meincke, Koln (DE)

Correspondence Address: BAYER MATERIAL SCIENCE LLC, 100 BAYER ROAD, PITTSBURGH, PA, 15205, US

(21) Appl. No.: 10/796,525

(22) Filed: Mar. 9, 2004

(30) Foreign Application Priority Data
Mar. 12, 2003 (DE) 10310693.6

(51) Int. Cl. C08K 3/04

(52) U.S. Cl. 524/495

(57) ABSTRACT

A thermoplastic molding composition is disclosed. The composition contains A) 25 to 75 parts by weight polyamide, B) 1 to 65 parts by weight graft polymer C) 0.05 to 5 parts by weight electrically conductive carbon nanofibrils and D) 0.5 to 30 parts by weight thermoplastic polymer the molecular structure of which contains at least one polar group. The composition and molded articles produced therefrom are distinguished by a good property profile with respect to elongation at break and electrical conductivity.

### FIELD OF THE INVENTION

The invention relates to thermoplastic molding composition s and more particularly to impact modified polyamide compositions mold.

### SUMMARY OF THE INVENTION

A thermoplastic molding composition is disclosed. The composition contains A) 25 to 75 parts by weight polyamide, B) 1 to 65 parts by weight graft polymer C) 0.05 to 5 parts by weight electrically conductive carbon nanofibrils and D) 0.5 to 30 parts by weight thermoplastic polymer the molecular structure of which contains at least one polar group, The composition and molded articles produced therefrom are distinguished by a good property profile with respect to elongation at break and electrical conductivity.

### BACKGROUND OF THE INVENTION

DE-A 101 019 225 describes polymer compositions in general containing polyamide, graft polymer, vinyl (co)polymer, compatibility agents and very fine-particle mineral particles with anisotropic particle geometry.

Polymer blends made of a polyamide, a styrene/acrylonitrile copolymer and a compatibility agent are known from EP 0 202 214 A. A copolymer made of a vinyl aromatic monomer and acrylonitrile, methacrylonitrile, C₁ to C₄-alkyl methacrylate or C₁ to C₄-alkyl acrylate in a weight ratio of 85:15 to 15:85 is used as the compatibility agent. Increased resistance to impact is to be achieved by the use of compatibility agents. Conductivity additives are not described.

Known from JP 11 241 016.A2 are polyamide molding compounds which, apart from polyamide, contain rubber modified styrene polymers, graft polymers based on ethylene/propylene rubbers and talc with a particle diameter of 1 to 4 μm.

EP-A 0 718 350 (=U.S. Pat. No. 5,484,838) describes polymer blends made of a crystalline and an amorphous or semi-crystalline polymer and 2 to 7% by weight electrically conductive carbon (carbon black) for producing molded, thermoplastic objects which are electrostatically painted in a further step.

A method is described in U.S. Pat. No. 4,974,307 of producing a car body from metal and plastics material which is then painted. For this purpose, molding compounds and molded articles produced therefrom and made of a polymer resin and a conductive material are described, the surface resistances of which are between 5×10² and 1×10⁶ Ω×cm. To achieve these high conductivities, a large amount of conductivity additive has to be added and this impairs the flowability and viscosity of the corresponding polymer molding compound.

Rubber modified polymer compositions are known from EP 0 785 234 A1 which contain a terpolymer made of styrene, acrylonitrile and maleic anhydride as the compatibility agent. The addition of the compatibility agents leads to an improvement in the mechanical properties, in particular the resistance to impact at low temperatures. However, it is disadvantageous that the overall property profile of the polymer, in particular the processing behavior during injection molding suffers with the addition of the compatibility agent.

### DETAILED DESCRIPTION OF THE INVENTION

It is the object of the present invention to provide conductive polyamide molding compounds which have an excellent property profile with respect to elongation at break and electrical conductivity and a good modulus of elasticity.

The present invention therefore relates to compositions containing polyamide and 0.05 to 5 parts by weight electrically conductive carbon particles and 1 to 65 parts by weight graft polymer.

A preferred polymer composition contains

(A) 25 to 75, preferably 30 to 70, particularly preferably 30 to 60 parts by weight polyamide

(B) 1 to 65, preferably 3 to 50, particularly preferably 5 to 55, in particular 15 to 50 parts by weight graft polymer

(C) 0.05 to 5, preferably 0.2 to 4, particularly preferably 0.5 to 3.5, parts by weight electrically conductive carbon nanofibrils and

(D) 0.5 to 30, preferably 1 to 20 parts by weight, thermoplastic polymers with polar groups.

The composition may contain as further components, for example vinyl (co)polymer (component E) and polymer additives (F) (such as stabilisers).

It has been found that the above composition exhibits an excellent combination of properties with respect to elongation at break and electrical conductivity. The compositions according to the invention also have good moduli of elasticity and are distinguished by a co-continuous morphology.

The components of the polymer composition suitable according to the invention are described hereinafter by way of example.

Component A

Polyamides which are suitable according to the invention (component A) are known or may be produced by methods known in the literature.

Polyamides which are suitable according to the invention are known homopolyamides, copolyamides and mixtures of these polyamides. These may be partially crystalline and/or amorphous polyamides. Polyamide-6, polyamide-6,6, mixtures and corresponding copolymers made of these components are suitable as partially crystalline polyamides. Possibilities also include partially crystalline polyamides, of which the acid component completely or partially consists of terephthalic acid and/or isophthalic acid and/or suberic acid and/or sebacic acid and/or azelaic acid and/or adipic acid and/or cyclohexanedicarboxylic acid, of which the diamine component completely or partially consists of m- and/or p-xylylenediamine and/or hexamethylenediamine and/or 2,2,4-trimethylhexame-thylenediamine and/or 2,4,4-trimethylhexamethylenediamine and/or isophorone-diamine and of which the composition is basically known.

Polyamides should also be mentioned which are produced completely or partially from lactams with 7 to 12 carbon atoms in the ring, optionally also using one or more of the above-mentioned starting components.

Particularly preferred partially crystalline polyamides are polyamide-6 and polyamide-6,6 and mixtures thereof. Known products may be used as amorphous polyamides. They are obtained by polycondensation of diamines such as ethylenediamine, hexamethylenediamine, decamethylenediamine, 2,2,4- and/or 2,4,4-trimethylhexamethylenediamine, m- and/or p-xylylenediamine, bis-(4-aminocyclohexyl)-methane, bis-(4-aminocyclohexyl)-propane, 3,3′-dimethyl-4,4′-diamino-dicyclohexyl methane, 3-aminomethyl-3,5,5-trimethylcyclohexylamine, 2,5- and/or 2,6-bis-(aminomethyl)-norbomane and/or 1,4-diaminomethyl-cyclohexane with dicarboxylic acids, such as oxalic acid, adipic acid, azelaic acid, decanedioic acid, heptadecanedicarboxylic acid, 2,2,4- and/or 2,4,4-trimethyladipic acid, isophthalic acid and terephthalic acid.

Copolymers obtained by polycondensation of a plurality of monomers are also suitable, and also copolymers produced with the addition of aminocarboxylic acids such as e-aminohexanoic acid, w-aminoundecanoic acid or w-aminolauric acid or their lactams.

Particularly suitable amorphous polyamides are the polyamides produced from isophthalic acid, hexamethylenediamine and further diamines such as 4,4-di-aminodicyclohexylmethane, isophoronediamine, 2,2,4- and/or 2,4,4-trimethyl-hexamethylenediamine, 2,5- and/or 2,6-bis-(aminomethyl)-norbomene; or from isophthalic acid, 4,4′-diaminodicyclohexylmethane and ε-caprolactam; or from isophthalic acid, 3,3′-dimethyl-4,4′-diaminodicylcohexylmethane and laurolactam; or from terephthalic acid and the isomeric mixture of 2,2,4- and/or 2,4,4-tri-methylhexamethylenediamine.

Instead of the pure 4,4′-diaminodicyclohexylmethane, mixtures of the positional isomers diaminedicyclohexylmethanes may be used which are composed of

| | |
|---|---|
| 70 to 99 mol % | 4,4′-diamino isomers, |
| 1 to 30 mol % | 2,4′-diamino isomers and |
| 0 to 2 mol % | 2,2′-diamino isomers, |

optionally corresponding to more highly condensed diamines obtained by hydrogenation of diaminodiphenylmethane of technical quality. Up to 30% of the isophthalic acid may be replaced by terephthalic acid.

The polyamides preferably have a relative viscosity (measured by a 1% by weight solution in m-cresol at 25° C.) of 2.0 to 5.0, particularly preferably 2.5 to 4.0.

One or more polyamides may be included in the inventive composition.

Component B

Component B comprises one or more rubber-modified graft polymers. The rubber-modified graft polymer B comprises a random (co)polymer made of vinyl monomers B.1, preferably according to B.1.1 and B.1.2, and a rubber B.2 grafted with vinyl monomers, preferably according to B.1.1 and B.1.2. B is produced in a known manner by radical polymerization, for example by an emulsion, mass or solution or mass-suspension polymerization method, such as, for example, described in U.S. Pat. No. 3,243,481, U.S. Pat. No. 3,509,237, U.S. Pat. No. 3,660,535, U.S. Pat. No. 4,221,833 and U.S. Pat. No. 4,239,863. ABS polymers which can be obtained by redox initiation with an initiator system made of organic hydroperoxide and ascorbic acid according to U.S. Pat. No. 4,937,285 are also particularly suitable graft rubbers.

Preferred are one or more graft polymers from 5 to 95, preferably 20 to 90% by weight, of at least one vinyl monomer B.1 on 95 to 5, preferably 80 to 10% by weight of one or more graft substrates B.2 with glass transition temperatures <10° C., preferably <−10° C.

Preferred monomers B.1.1 are styrene, α-methyl styrene, styrenes substituted in the nucleus with halogen or alkyl such as p-methyl styrene, p-chlorostyrene, (meth)acrylic acid-C₁-C₈-alkyl ester such as methyl methacrylate, n-butyl acrylate, tert.-butyl acrylate. Preferred monomers B.1.2 are unsaturated nitriles such as acrylonitrile, methacrylonitrile, (meth)acrylic acid-C₁-C₈-alkyl esters such as methyl methacrylate, n-butyl acrylate, tert.-butyl acrylate, derivatives (such as anhydrides and imides) of unsaturated carboxylic acids such as maleic anhydride and N-phenyl-maleinimide or mixtures thereof.

Particularly preferred monomers B.1.1 are styrene, α-methyl styrene and/or methyl methacrylate, particularly preferred monomers B.1.2 are acrylonitrile, maleic anhydride and/or methyl methacrylate.

Particularly preferred monomers are B.1.1 styrene and B.1.2 acrylonitrile.

Examples of rubbers B.2 suitable for rubber-modified graft polymers B include diene rubbers, acrylate, polyurethane, silicone, chloroprene and ethylene/-vinylacetate rubbers. Composites of various said rubbers are also suitable as graft substrates.

Preferred rubbers B.2 are diene rubbers (for example based on butadiene, isoprene, etc.) or mixtures of diene rubbers or copolymers of diene rubbers or their mixtures with further copolymerizable vinyl monomers (for example according to B.1.1 and B.1.2), with the proviso that the glass transition temperature of the components B.2 is below 10° C., preferably below −10° C. Pure polybutadiene rubber is particularly preferred. Further copolymerizable monomers may be contained in the rubber substrate up to 50% by weight, preferably up to 30, in particular up to 20% by weight (based on the rubber substrate B.2).

Suitable acrylate rubbers according to B.2 of polymers B are preferably polymers made of acrylic acid alkyl esters optionally with up to 40% by weight, based on B.2, of other polymerisable, ethylenically unsaturated monomers. Examples of preferred polymerizable acrylic acid esters are C₁ to C₈-alkyl ester, for example methyl, ethyl, butyl, n-octyl and 2-ethylhexyl ester; halogen alkyl ester, preferably halogen-C₁-C₈ alkyl ester, such as chloroethylacrylate and mixtures of these monomers.

It is particularly preferred that the graft substrate of the graft polymer is not an ethylene-propylene rubber (EPR) or rubber based on ethylene-propylene and non-conjugated diene (EPDM).

Preferred “other” polymerisable, ethylenically unsaturated monomers which, apart from the acrylic acid esters may optionally serve to produce the graft substrate B.2, are for example acrylonitrile, styrene, α-methyl styrene, acrylamides, vinyl-C₁-C₆-alkyl ether, methyl methacrylate, butadiene. Preferred acrylate rubbers as the graft substrate B.2 are emulsion polymers which have a gel content of at least 60% by weight.

Further suitable graft substrates according to B.2 are silicone rubbers with graft-active points as described in DE-A 3 704 657, DE-A 3 704 655, DE-A 3 631 540 and DE-A 3 631 539.

The gel content of the graft substrate B.2 is determined at 25° C. in a suitable solvent (M. Hoffmann, H. Krömer, R. Kuhn, Polymeranalytic I und II, Georg Thieme-Verlag, Stuttgart 1977).

The mean particle size d₅₀ is the diameter above and below which 50% by weight of the particles are located, in each case. It may be determined by ultracentrifugation (W. Scholtan, H. Lange, Kolloid, Z. und Z. Polymere 250 (1972), 782-1796).

Component B may also contain, if necessary and if the rubber properties of component B.2 are not impaired thereby, small quantities, generally less than 5% by weight, preferably less than 2% by weight based on B.2., of ethylenically unsaturated crosslinking monomers. Examples of such crosslinking monomers are esters of unsaturated monocarboxylic acids with 3 to 8 carbon atoms and unsaturated monovalent alcohols with 3 to 12 carbons atoms, or saturated polyols with 2 to 4 OH groups and 2 to 20 carbon atoms, multiply unsaturated heterocyclic compounds, polyfunctional vinyl compounds, such as alkylenediol-di(meth)-acrylates, polyester-di(meth)-acrylates, divinylbenzene, trivinylbenzene, trivinyl cyanurate, triallyl cyanurate, allyl-(meth)-acrylate, diallyl maleate, diallylfumerate, triallyl phosphate and diallyl phthalate.

Preferred crosslinking monomers are allyl methacrylate, ethyleneglycol dimethacrylate, diallyl phthalate and heterocyclic compounds which have at least three ethylenically unsaturated groups.

The rubber modified graft polymer B, in the case of production by means of mass or solution or mass-suspension polymerization, is obtained by graft polymerization of 50 to 99, preferably 65 to 98, particularly preferably 75 to 97 parts by weight of a mixture of 50 to 99, preferably 60 to 95 parts by weight monomers according to B.1.1 and 1 to 50, preferably 5 to 40 parts by weight monomers according to B.1.2 in the presence of 1 to 50, preferably 2 to 35, particularly preferably 2 to 15, in particular 2 to 13 parts by weight of the rubber components B.2.

The mean particle diameter d₅₀ of the grafted particles generally has values of 0.05 to 10 μm, preferably 0.1 to 5 μm, particularly preferably 0.2 to 1 μm.

The mean particle diameter d₅₀ of the resultant grafted rubber particles which are obtainable by means of mass or solution or mass-suspension polymerization methods (determined by counting out electron microscope images) is generally in the range of 0.5 to 5 μm, preferably from 0.8 to 2.5 μm.

The graft copolymers may be contained alone or in any mixture with one another in component B.

Component C

Carbon nanofibrils according to the invention typically have the form of tubes formed from graphite layers. The graphite layers are concentrically arranged around the cylinder axis.

Carbon nanofibrils have a length to diameter ratio of at least 5, preferably at least 100, particularly preferably at least 1,000. The diameter of the nanofibrils is typically in the range of 0.003 to 0.5 μm, preferably in the range of 0.005 to 0.08 μm, particularly preferably in the range of 0.006 to 0.05 μm. The length of the carbon nanofibrils is typically 0.5 to 1,000 μm, preferably 0.8 to 100 μm, particularly preferably 1 to 10 μm. The carbon nanofibrils have a hollow cylindrical core around which the graphite layers are formally wound (i.e. the graphite layers are twised (or wound) around the hollow core). This cavity typically has a diameter of 0.001 to 0.1 μm, preferably a diameter of 0.008 to 0.015 μm. In a typical embodiment of the carbon nanofibrils, the wall of the fibrils around the cavity may include eight graphite layers. The carbon nanofibrils may be present here as aggregates of up to 1,000 μm in diameter, preferably up to 500 μm in diameter made of a plurality of nanofibrils. The aggregates may have the form of birds' nests, of combed yarn or of open network structures.

The carbon nanofibrils may be added prior to, during or after polymerization of the monomers to form the thermoplastic material of component A). If the carbon nanofibrils are added after polymerization, this preferably takes place by addition to the thermoplastic melt in an extruder or in a mixer. In particular the already described aggregates may be largely or even completely comminuted by the compounding process in the mixer or extruder and the carbon nanofibrils may be dispersed in the thermoplastic material matrix.

In a preferred embodiment, the carbon nanofibrils may be added as highly concentrated master batches to thermoplastics materials which are preferably selected from the group of thermoplastic materials used as component A). The concentration of the carbon nanofibrils in the master batches is in the range of 5 to 50, preferably 8 to 30, particularly preferably in the range of 12 to 22% by weight, based on the master batch. The production of master batches is described for example in U.S. Pat. No. 5,643,502. In particular the comminution of the aggregates may be improved by the use of master batches. The carbon nanofibrils, owing to the processing into the molding composition or molded article may have shorter length distributions than originally used in the molding composition or in the molded article.

Carbon nanofibrils are marketed for example by Hyperion Catalysis or Applied Sciences Inc. The carbon nanofibrils are synthesised in a reactor containing a gas containing a carbon and a metal catalyst, as is described, for example, in U.S. Pat. No. 5,643,502.

Component D

Thermoplastic polymers the molecular structure of which include at least one polar group are preferably used as the compatibility agent, component D).

Polymers are used according to the invention which contain

D.1 a vinyl aromatic monomer,

D.2 at least one monomer selected from the group C₂ to C₁₂-alkyl methacrylates, C₂ to C₁₂-alkyl acrylates, methacrylonitriles and acrylonitriles and

D.3 α,β-unsaturated components containing dicarboxylic acid anhydrides.

Styrene is particularly preferred as the vinyl aromatic monomers D.1, acrylonitrile is particularly preferred as component D.2, maleic anhydride is particularly preferred as the dicarboxylic acid anhydrides containing α,β-unsaturated components D.3.

Terpolymers of the aforementioned monomers are preferably used as component D. Accordingly, terpolymers of styrene, acrylonitrile and maleic anhydride are preferably used. These terpolymers contribute in particular to improving the mechanical properties, such as tensile strength and elongation at break. The quantity of maleic anhydride in the terpolymer may vary within wide limits. The quantity is preferably 0.2 to 5 mol %. Particularly preferred are quantities between 0.5 and 1.5 mol %. Particularly good mechanical properties with respect to tensile strength and elongation at break are achieved in this range.

The terpolymer may be produced in known manners e. A suitable method is the dissolving of monomer components of the terpolymer, for example of the styrene, maleic anhydride or acrylonitrile in a suitable solvent, for example methyl ethyl ketone (MEK). One or optionally more chemical initiators are added to this solution. Suitable initiators are, for example, peroxides. The mixture is then polymerized for several hours at elevated temperatures. The solvent and the unreacted monomers are then removed in known manners.

The ratio between component D.1 (vinyl aromatic monomer) and component D.2, for example the acrylonitrile monomer in the terpolymer is preferably between 80:20 and 50:50. To improve the miscibility of the terpolymer with the graft copolymer B a quantity of vinyl aromatic monomer D.1 is preferably selected which corresponds to the quantity of the vinyl monomer B.1 in the graft polymer B.

Examples of the compatibility agents D which may be used according to the invention are described in EP-A 785 234 and EP-A 202 214. Preferred according to the invention are in particular the polymers mentioned in EP-A 785 234.

One or more compatibility agents may be contained in the composition as component D.

A further substance particularly preferred as a compatibility agent is a terpolymer of styrene and acrylonitrile in a weight ratio 2.1:1 containing 1 mol % maleic anhydride.

The quantity of component D in the polymer composition according to the invention is preferably between 0.5 and 30 parts by weight, in particular between 1 and 20 parts by weight and particularly preferably between 2 and 10 parts by weight. Quantities between 3 and 7 parts by weight are most preferred.

Component E

Component E comprises one or more thermoplastic vinyl (co)polymers.

Suitable vinyl (co)polymers are polymers of at least one monomer from the group of vinyl aromatics, vinyl cyanides (unsaturated nitrites), (meth)acrylic acid-(C₁-C₈)-alkyl esters, unsaturated carboxylic acids and derivatives (such as anhydrides and imides) of unsaturated carboxylic acids. Suitable in particular are (co)polymers made of

E.1 50 to 99, preferably 60 to 80 parts by weight vinyl aromatics and/or vinyl aromatics substituted in the nucleus (such as styrene, α-methyl styrene, p-methyl styrene, p-chlorostyrene) and/or methacrylic acid-(C₁-C₈)-alkyl ester (such as methyl methacrylate, ethyl methacrylate), and

E.2 1 to 50, preferably 20 to 40 parts by weight vinyl cyanides (unsaturated nitriles) such as acrylonitrile and methacrylonitrile and/or (meth)acrylic acid-(C₁-C₈)-alkyl ester (such as methyl methacrylate, n-butyl acrylate, tert.-butyl acrylate) and/or imides of unsaturated carboxylic acids (for example N-phenylmaleic imide).

(Co)polymers E are resinous, thermoplastic and free of rubber.

Particularly preferred is the copolymer from E.1 styrene and E.2 acrylonitrile. (Co)polymers E are known and may be produced by radical polymerization, in particular by emulsion, suspension, solution or mass polymerization. The (co)polymers preferably have weight average molecular weights Mw (weight averages determined by light scattering or sedimentation) between 15,000 and 200,000.

The vinyl (co)polymers may be contained in component E alone or in any mixture with one another.

Component E is preferably contained in the polymer composition in a quantity of 0 to 40 parts by weight, in particular 0 to 30 parts by weight and particularly preferably from 5 to 25 parts by weight.

Component F

The polymer compositions according to the invention may contain conventional additives, such as fireproofing agents, anti-dripping agents, lubricants and demolding agents, nucleation agents, antistatics, stabilizers, fillers and reinforcing materials, and dyes and pigments and hydrophobing agents such as phenolformaldehyde resins.

The compositions according to the invention may generally contain 0.01 to 20 parts by weight, based on the total composition, fireproofing agents. Mentioned as examples of fireproofing agents are organic halogen compounds such as decabromodiphenyl ether, tetrabromobisphenol, inorganic halogen compounds such as ammonium bromide, nitrogen compounds such as melamine, melamine formaldehyde resins, inorganic hydroxide compounds such as Mg—Al-hydroxide, inorganic compounds such as aluminium oxides, titanium dioxides, antimony oxides, barium metaborate, hydroxoantimonate, zirconium oxide, zirconium hydroxide molybdenum oxide, ammonium molybdate, tin borate, ammonium borate and tin oxide as well as siloxane compounds.

Phosphorus compounds such as are described in EP-A 363 608, EP-A 345 522 and/or EP-A 640 655, may also be used as fireproofing compounds.

Suitable filling and reinforcing materials are for example glass fibers, optionally cut or ground, glass beads, glass marbles, silicates, quartz and titanium dioxide or mixtures thereof. Cut or ground glass fibers are preferably used as reinforcing material.

Suitable hydrophobing agents are, for example, phenol formaldehyde resins. They are preferably produced by a condensation reaction from phenols with aldehydes, preferably formaldehyde, by derivatization of the condensates resulting in the process or by the addition of phenols to unsaturated compounds, such as for example acetylene, terpenes, etc. Condensation may take place here in an acidic or alkaline manner and the mol ratio of aldehyde to phenol may be from 1:0.4 to 1:2.0. This produces oligomers or polymers with a molar mass of 150 to 5,000 g/mol. The molding compounds preferably contain phenol formaldehyde resins which are preferably added in a quantity of up to 15, preferably 1 to 12 and in particular 2 to 8 parts by weight.

All the part by weight details in this application should be standardized such that the total of the parts by weight of all the components is set to equal 100.

The compositions according to the invention are produced in that the respective constituents are mixed in a known manner and melt compounded and melt extruded at temperatures of 200° C. to 300° C. in conventional units such as internal mixers, extruders and double shaft screws, the demolding agent being used in the form of a coagulated mixture.

The individual constituents may be mixed in known manner either successively or simultaneously, and more precisely either at about 20° C. (room temperature) or at a higher temperature.

The polymer compositions according to the invention may be used to produce molded articles of any type. In particular, molded articles may be produced by injection molding. Examples of molded articles are: housing parts of any type, for example for household devices such as electric razors, flat screens, monitors, printers, copiers, or covering panels for the building industry and parts for motor vehicles and rail vehicles. They may also be used in the electrotechnology area as they have very good electrical properties.

The polymer compositions according to the invention may furthermore be used, for example, to produce the following molded articles:

Internal finishing parts for rail vehicles, ships, buses, other motor vehicles and aircraft, wheel covers, housings of electrical devices containing small transformers, housings for devices for disseminating and transmitting information, flat wall elements, housings for safety devices, rear spoilers and other body parts for motor vehicles, heat-insulating transport containers, a device for holding or looking after small animals, covering grids for ventilator openings, molded articles for garden and tool sheds, housings for garden tools.

A further form of processing is the production of molded articles by thermoforming from previously produced sheets or films.

A further subject of the present invention is therefore also the use of the compositions according to the invention to produce molded articles of every type, preferably the above-mentioned parts, and molded articles from the compositions according to the invention.

The following examples serve to further explain the invention.

### EXAMPLES

Components Used

Component A

Polyamide 6: Durethang® 29 from Bayer AG.

Component B

Graft polymer of 40 parts by weight of copolymer made of styrene and acrylonitrile in a ratio 73:27 on 60 parts by weight particulate crosslinked polybutadiene rubber (mean particle diameter d₅₀=0.28 mm), produced by emulsion polymerisation.

Component C1

The conductivity additive C) is used in the form of a master batch. C1 is a master batch with 20% by weight of carbon nanofibrils in polyamide 6 (carbon nanotubes from Hyperion Catalysis International, Cambridge, Mass. 02138, USA).

Component D

Terpolymer of styrene and acrylonitrile with a weight ratio of 2.1:1 containing 1 mol % maleic anhydride.

Component E

Styrene/acrylonitrile copolymer with a styrene/acrylonitrile weight ratio of 72:28 and an intrinsic viscosity of 0.55 dl/g (measurement in dimethyl formamide at 20° C.).

Formulations A and B are used in examples in the following table:

| | |
|---|---|
| Formulation A | |
| X in % by weight: | blend of polyamide according to component A) and |
| | master batch of polyamide and nanofibrils according |
| | to component C1 |
| 100-X in % by | mixture of component B (67% by weight), |
| weight: | component E (33% by weight) and |
| Formulation B | |
| X in % by | blend of polyamide according to component A) and |
| weight: | 20% by weight master batch of polyamide and |
| | nanofibrils according to component C1 |
| 100-X in % by | mixture of component B (59.6% by weight), |
| weight: | component E (29.4% by weight) and component D |
| | (11% by weight). |

The formulations A and B each also contain 1% additives believed to have no criticality to the invention.

The individual constituents are mixed and compounded in a twin screw extruder at 260° C.

Measuring Methods

Tensile Strength Measurements

Tensile strength properties were measured with an Instron traction machine (Model 4202) to ISO regulation 527. A 5 kN load cell was used. The bone-shaped test specimens were 150 mm in length and 4 mm thick, the spacing between the pulling heads was 115 mm, the test body measuring length 101.5 mm. The Young module was measured to ISO 1873-2 at a cross-head speed of 1 mm/min with an extensometer of 50 mm measuring length. The evaluation took place with the aid of the chord method, in which a straight line is placed through the two measuring points at 0.05% and 0.25% elongation. At least six test specimens were measured. Yield stress and elongation at break were determined with a cross-head speed of 50 mm/min.

Conductivity Measurement

The electrical conductivity was determined by the two point method. DMA test specimens were prepared for this. DMA stands for dynamic mechanical analysis. The DMA test specimens used were produced by injection molding in the dimension of 50 mm×6 mm×2 mm. These DMA test specimens were cooled with liquid nitrogen so the rubber phase was frozen and was, subsequently also broken. The broken pieces measured 6 mm×2 mm and a thickness of typically about 2 mm. The thickness is measured in each case and used for the calculation of the specific resistance.

The current strength/voltage curve was recorded with the aid of a Zahner electric IM5d potentiostat. The precise measurements of the test specimen were then determined and the specific resistance R_{spec} calculated according to equation (1).

By measuring the current intensity/voltage curves in a range in which the test specimen behaves like an ohmic resistance, the resistance of the body may be calculated from the gradient of the straight line. After determining the precise dimensions of the broken piece the specific resistance R_{spec} is calculated in Ω cm:

$${R}_{spec} = \frac{R \cdot L}{F} \qquad ( equation 1 )$$

wherein

R=resistance in Ω,

L=spacing between the two contact faces in cm and

F=size of a face in cm².

TABLE 1
(Quantity details in % by weight based on the total composition)

| | PA | | | | Elongation | |
|---|---|---|---|---|---|---|
| Ex- | master- | Comp. C | | E- | at | Spec. |
| am- | batch | (nano- | Formu- | modulus | break | resistence |
| ple | (X %) | tube) | lation | [Mpa] | [%] | [Ω/cm] |
| 1V | 40 | 2.0 | A | 1829 | 19 | 330 100 |
| 2E | 40 | 2.0 | B | 2118 | 55 | 154 000 |

V = comparison
E = according to the invention

The reduction in the spec. resistance when the same quantity of conductivity additive is added to the composition can clearly be seen. (Example 1V, 2E). Thus apart from an increase in the modulus of elasticity and the elongation at break, an increase in the conductivity by more than double is obtained (cf. 1V and 2E).

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A thermoplastic molding composition comprising
A) 25 to 75 parts by weight polyamide
B) 1 to 65 parts by weight graft polymer
C) 0.05 to 5 parts by weight electrically conductive carbon nanofibrils and
D) 0.5 to 30 parts by weight thermoplastic polymer the molecular structure of which contains at least one polar group.

2. The composition according to claim 1, containing
30 to 70 percent by weight component A)
3 to 50 percent by weight component B)
0.2 to 4 percent by weight component C) and
1 to 20 percent by weight component D).

3. The composition according to claim 1, containing at least one further component selected from the group consisting of rubber-free vinyl (co)polymers and conventional polymer additives.

4. The composition according to claim 1, wherein the graft polymer contains a grafted phase polymerized of at least one vinyl monomer grafted onto a substrate having a glass transition temperature ≦10° C.

5. The composition according to claim 4, wherein the grafted phase is polymerized of
B.1.1 at least one member selected from the group consisting of styrene, α-methyl styrene, styrenes substituted in the nucleus with halogen or alkyl, (meth)acrylic acid-C₁-C₈-alkyl ester and
B.1.2 at least one member selected from the group consisting of unsaturated nitrites, (meth)acrylic acid-C₁-C₈-alkyl esters and derivatives of unsaturated carboxylic acids
and the substrate has a glass transition temperature ≦10° C.

6. The composition according to claim 5, wherein the substrate is at least one member selected from the group consisting of diene rubbers, copolymers of diene rubbers, acrylate rubbers, polyurethane silicone rubbers, chloroprene rubbers and ethylene/vinyl acetate rubbers.

7. The composition according to claim 5, wherein the substrate is at least one member selected from the group consisting of diene rubbers, copolymers of diene rubbers, acrylate rubbers and ethylene/propylene rubbers.

8. The composition according to claim 7, wherein the substrate is polybutadiene.

9. The composition according to claim 1 wherein D) is a terpolymer of
D.1 a vinyl aromatic monomer,
D.2 at least one monomer selected from the group comprising C₂ to C₁₂-alkyl methacrylates, C₂ to C₁₂-alkyl acrylates, acrylonitrile and methacrylonitrile and
D.3 at least one α,β-unsaturated component containing dicarboxylic acid anhydride.

10. A molded article comprising the composition of claim 1.
